(19) United States
(12) Patent Application Publication
(10) Pub. No.: US 2025/0374381 A1
(43) Pub. Date: Dec. 4, 2025

(54) MULTI-LEVEL CRISPY FOOD COOKER

(71) Applicant: Encore Group, Los Angeles, CA (US)

(72) Inventors: Armaan Darian Meshkati, Los Angeles, CA (US); Shahed Meshkati, Los Angeles, CA (US); Jesse Knight, Clearwater, FL (US); Philip D’Almada Remedios, Palm Harbor, FL (US)

(21) Appl. No.: 18/888,654

(22) Filed: Sep. 18, 2024

Related U.S. Application Data
(60) Provisional application No. 63/654,507, filed on May 31, 2024.

(51) Int. Cl. H05B 6/06; H05B 6/10; H05B 6/12

(52) U.S. Cl. CPC H05B 6/062; H05B 6/105; H05B 6/1245; H05B 2213/05

(57) ABSTRACT

A multi-level crispy food cooker and method of using thereof is disclosed. The multi-level food cooker may make a variety of foods—such as crispy rice, also known as tahdig—using induction heating. The multi-level food cooker may have an outer shell body that holds a plurality of containers and a plurality of inductive coils. The plurality of containers may be made, at least partially, from ferrous material and hold the ingredients for making crispy rice. The plurality of inductive coils may be configured to automatically turn on when detecting the presence of the containers in the correct position relative to the inductive coils.

### CROSS-REFERENCE TO RELATED APPLICATIONS

This application claims priority to Prov. patent application Ser. No. 63/654,507, filed on 2024 May 31, the entire contents of which are expressly incorporated herein by reference.

### STATEMENT RE: FEDERALLY SPONSORED RESEARCH/DEVELOPMENT

Not Applicable

### BACKGROUND

The various aspects and embodiments described herein relate to a crispy food cooker and method of using thereof.

Crispy rice, or tahdig, is a traditional culinary dish made in many cultures, especially in the Persian culture. Crispy rice is made by cooking rice, usually basmati rice, which contacts the bottom of the pot until such rice is goldened and crisped. In other variations of such dish, especially in the Persian culture, potatoes, breads (e.g., lavash bread), or even pastas are used to make tahdig. Crispy rice is a byproduct of cooking a full pot of rice. The rice can either be simple white rice or a mixed rice with various herbs and proteins. With current ways of making crispy rice, there are certain deficiencies.

Accordingly, there is a need in the art for an improved device, system, and method for making crispy rice and other crispy foods in the form of tahdig.

### BRIEF SUMMARY

The various embodiments and aspects disclosed herein address the needs discussed above, discussed below, and those that are known in the art. Using the device and method discussed herein will provide a larger volume of crispy rice and allows the user to make a variety of tahdig without having to make a full pot of simple white rice or the mixed rice.

A multi-level crispy rice maker and method of using thereof is disclosed. The multi-level crispy rice maker may make crispy rice (also known as tahdig) using induction heating Other types of tahdigs having mixed ingredients with rice or other ingredients such as potatoes, breads, or pastas may also be made with such device. The multi-level crispy rice maker may have an outer shell body that holds a plurality of containers and a plurality of inductive coils. The plurality of containers may either stack on top of each other or slide inside the outer shell body. The plurality of containers may be made, at least partially, from ferrous material (i.e., iron material) and hold the ingredients for making crispy rice. The plurality of inductive coils may come in different shapes depending on how the plurality of containers are placed inside the outer shell body. The plurality of inductive coils may be configured to automatically turn on when detecting the presence of the containers in the correct position relative to the inductive coils. Such automatic turning on may be accomplished by the inductive coils generating magnetic fields and sensing eddy currents generated within the containers and relaying such information to the processor of the multi-level crispy rice maker.

More particularly, a multi-level crispy food cooker is disclosed that may have an outer shell body having an interior with a plurality of cavity levels compartmentalized by one or more horizontal dividers, the outer shell body having an opening for each cavity level that is each covered by an outer casing structure having a gripping handle, a plurality of slidable containers, each slidable container corresponding to one of the plurality of cavity levels, each slidable container attached to a corresponding outer casing structure covering each cavity level, each slidable container made from a ferrous material and configured to slide inwards and outwards of a corresponding cavity level using the corresponding outer casing structure, a plurality of heating mechanisms corresponding to the plurality of cavity levels, each heating mechanism on a bottom surface of each cavity level, each heating mechanism having an inductive coil that is covered by a heat-resistive material, and a control panel on an outside of the outer shell body and configured to operate the multi-level crispy food cooker.

In some embodiments, each slidable container has a container body and a container lid. In some embodiments, the container body of each slidable container has an inner segment and an outer segment. In some embodiments, the inner segment is made from a food-safe material and the outer segment is made from ferrous material.

In some embodiments, the multi-level crispy rice cooker further has a processor inside the outer shell body and connected to the plurality of heating mechanisms. In some embodiments, the processor controls the plurality of heating mechanisms and is configured to determine to turn on for operation which inductive coil of each heating mechanism by detecting the ferrous material of the plurality of slidable containers using the inductive coil of each heating mechanism. In some embodiments, the processor is configured to determine to turn on for operation one or more of the inductive coils by partially turning on one or more of the inductive coils of the plurality of heating mechanisms and determining which one or more of the inductive coils is detecting eddy current.

In some embodiments, the heating temperature of each heating mechanism is adjustable using the control panel.

In some embodiments, the multi-level crispy food cooker is also configured to be operated by a mobile device. In some embodiments, the mobile device is connected to the multi-level crispy food cooker by Bluetooth or Wi-Fi.

Furthermore, another embodiment of a multi-level crispy food cooker is disclosed that may have a body having an outer shell and an inner wall and a gap therebetween, the inner wall defining a stacking cavity in a center of the body, a plurality of inductive coil rings stacked above each other in the gap between the outer shell and the inner wall of the body, the plurality of inductive coil rings encircling the stacking cavity, a plurality of stackable containers each made from a ferrous material stacked on top of each other in the stacking cavity, a processor inside the body and connected to the plurality of inductive coil rings, and a control panel on an outside of the body, the control panel configured to for controlling one or more operations of the multi-level crispy food cooker.

In some embodiments, the plurality of stackable containers come in different depth heights.

In some embodiments, each stackable container has a container body and a container lid. In some embodiments, the container body of each stackable container has an inner segment and an outer segment. In some embodiments, the inner segment is made from a food-safe material and the outer segment is made from ferrous material.

In some embodiments, the multi-level crispy food cooker is also configured to be operated by a mobile device.

In some embodiments, the inner segment of each stackable container has a non-stick coating in an interior surface of the container body.

In some embodiments, the processor is electrically connected to the plurality of inductive coil rings and configured to determine to turn on for operation one or more of said inductive coil rings by detecting the ferrous material of the plurality of stackable containers using the plurality of inductive coil rings. In some embodiments, the processor is configured to determine to turn on for operation one or more of the inductive coil rings by partially turning on each one or more of the inductive coil rings of the plurality of inductive coil rings and determining which one or more of the inductive coil rings is detecting eddy current.

In some embodiments, the mobile device is connected to the multi-level crispy food cooker by Bluetooth or Wi-Fi.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A shows a perspective view of one example of a multi-level crispy rice maker;

FIG. 1B shows a front view of the multi-level crispy rice maker of FIG. 1A;

FIG. 2A shows a cross-sectional view of the multi-level crispy rice maker of FIG. 1A;

FIG. 2B shows a different example of the cross-sectional view shown in FIG. 2A;

FIG. 3A shows a perspective view of a stackable container shown in FIG. 2A;

FIG. 3B shows a cross-sectional view of a stackable container shown in FIG. 2A;

FIG. 4 shows a perspective view of an inductive coil ring shown in FIG. 2A;

FIG. 5A shows a cross-sectional perspective view of a multi-level crispy rice maker having stackable containers with the same depth;

FIG. 5B shows a cross-sectional perspective view of another multi-level crispy rice maker having stackable containers with different depths;

FIG. 5C shows a cross-sectional perspective view of another multi-level crispy rice maker having stackable containers with different depths;

FIG. 6 is a block diagram of the relations of some of the electrical components in an embodiment of the multi-level crispy rice maker;

FIG. 7A shows a perspective view of another embodiment of a multi-level crispy rice maker;

FIG. 7B shows a front view of the multi-level crispy rice maker of FIG. 7A;

FIG. 8 shows a cross-sectional view of the multi-level crispy rice maker of FIG. 7A;

FIG. 9A shows a perspective view of a slidable container shown in FIG. 8;

FIG. 9B shows a cross-sectional view of a slidable container shown in FIG. 8;

FIG. 10 shows a perspective view of a disk-shaped inductive coil used in a heating mechanism shown in FIG. 8; and

FIG. 11 shows a block diagram of a method to use the multi-level crispy rice maker to make crispy rice.

### DETAILED DESCRIPTION

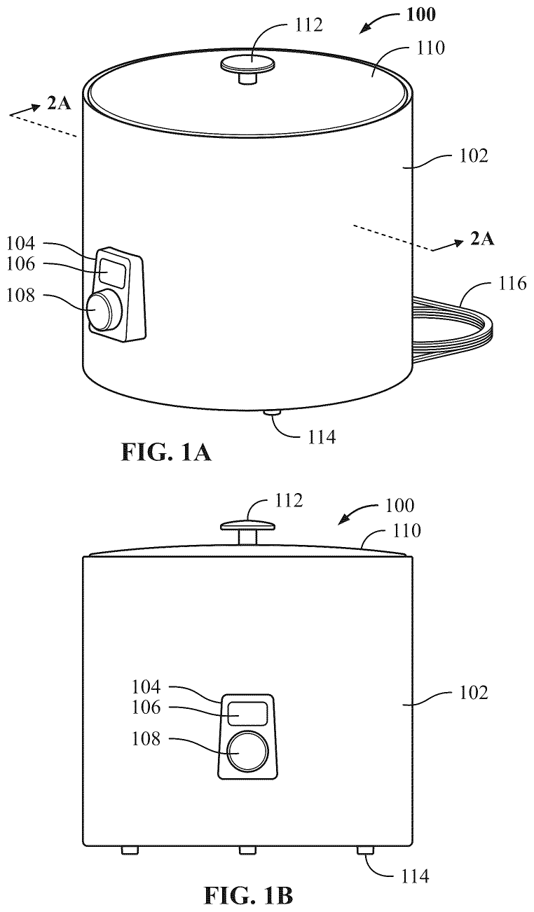

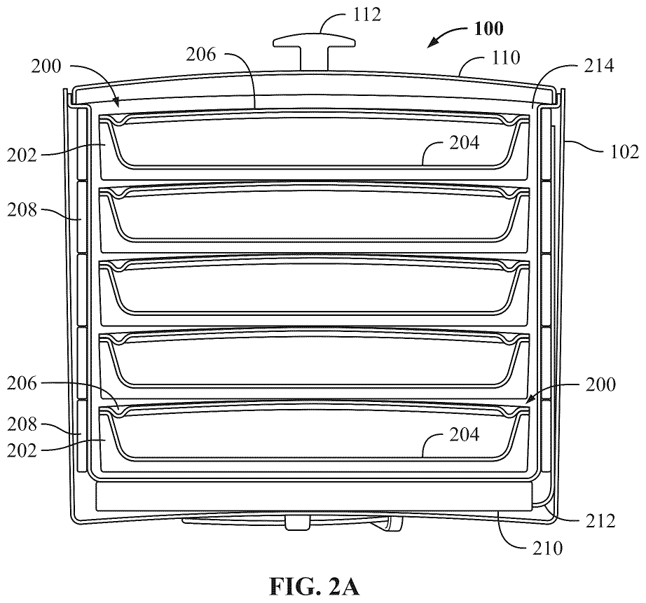

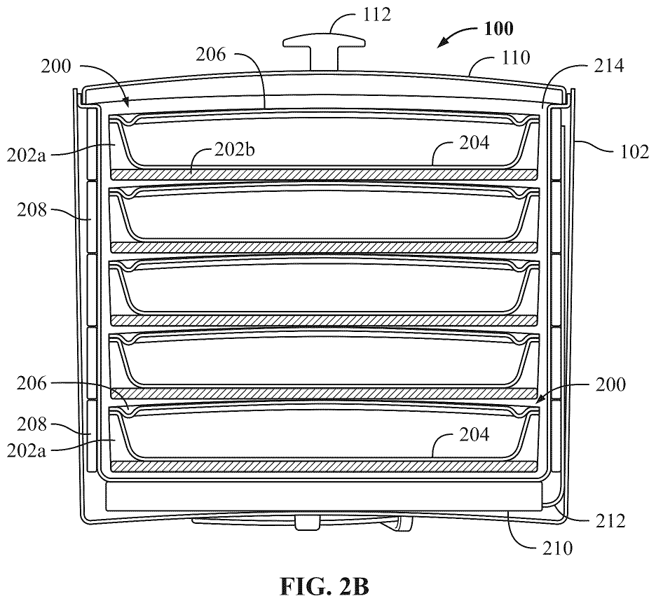

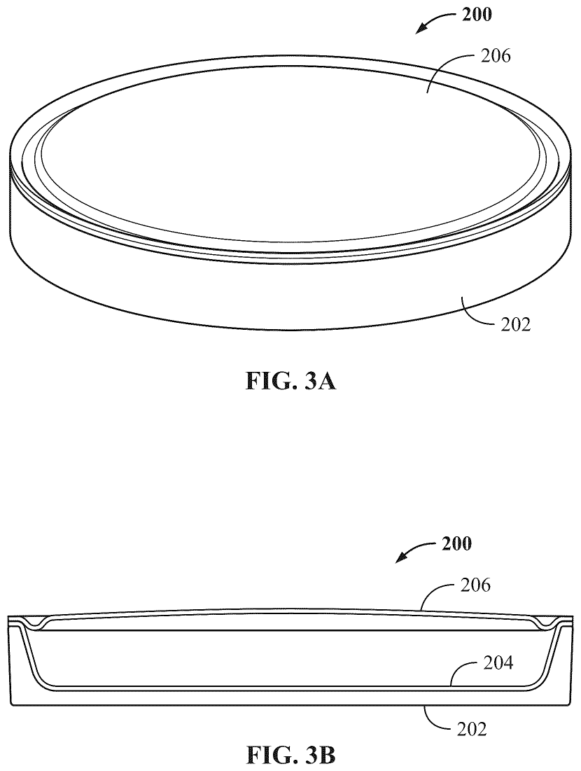

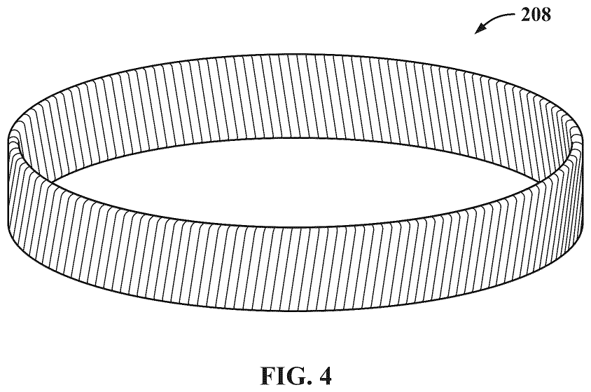

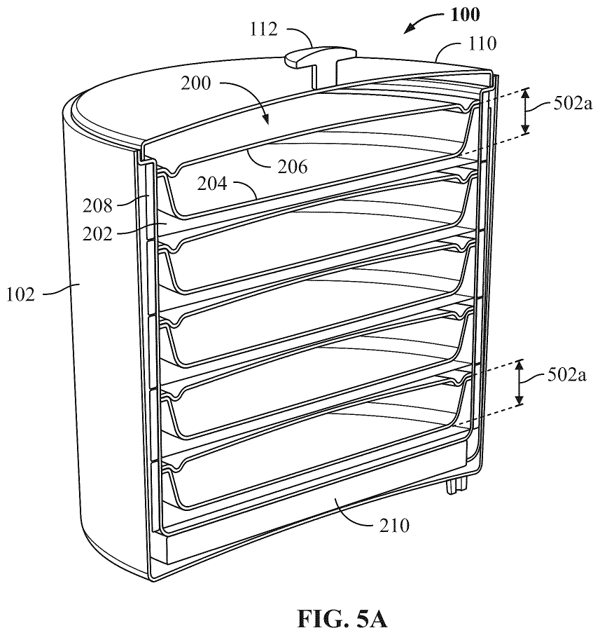

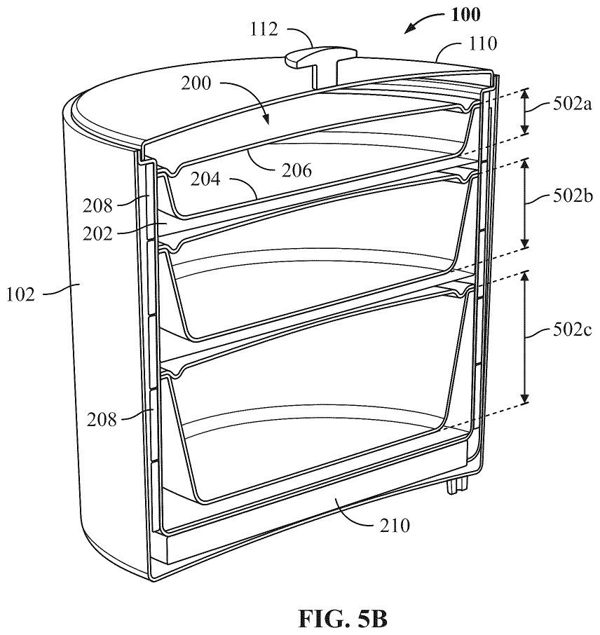

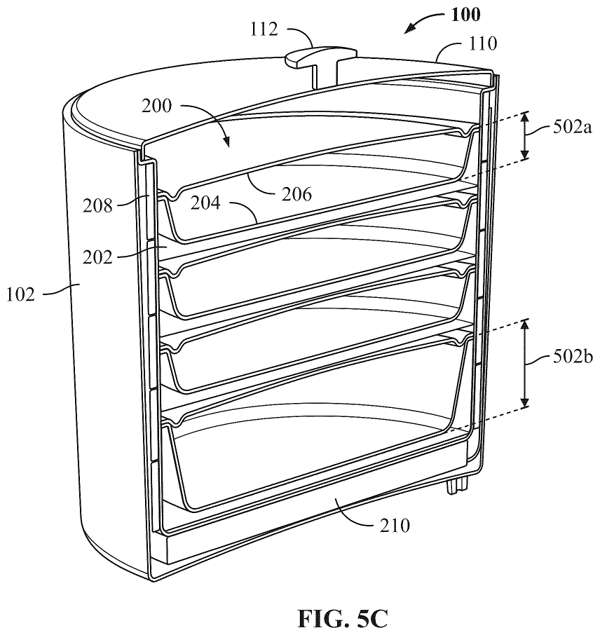

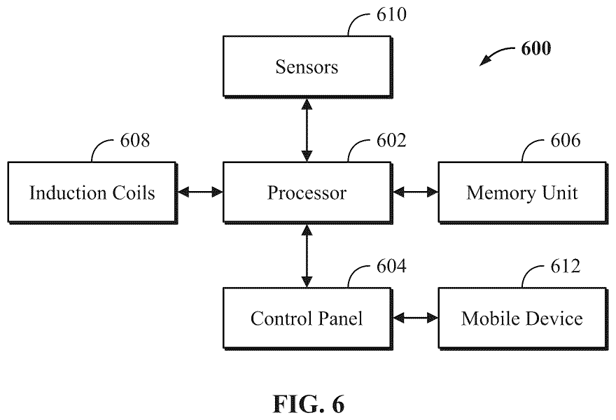

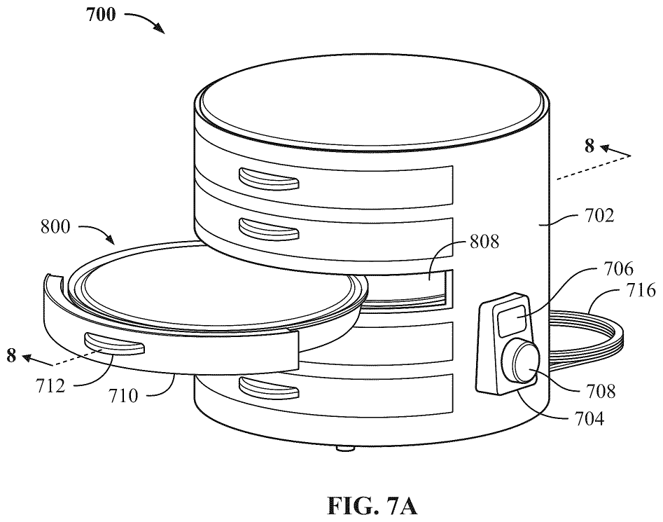

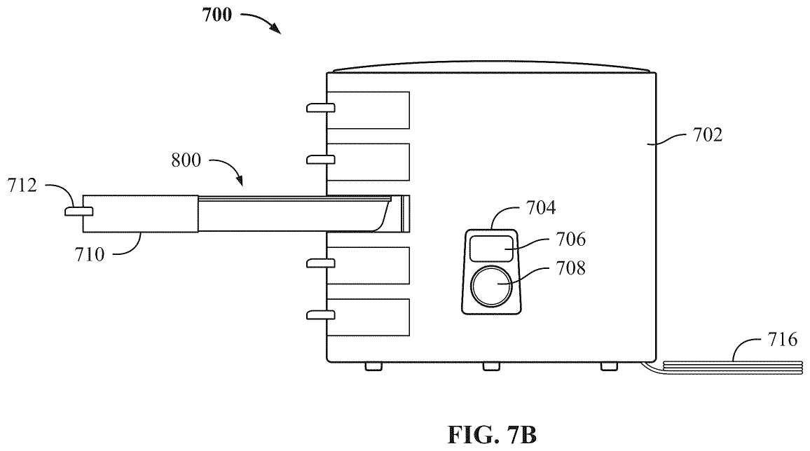

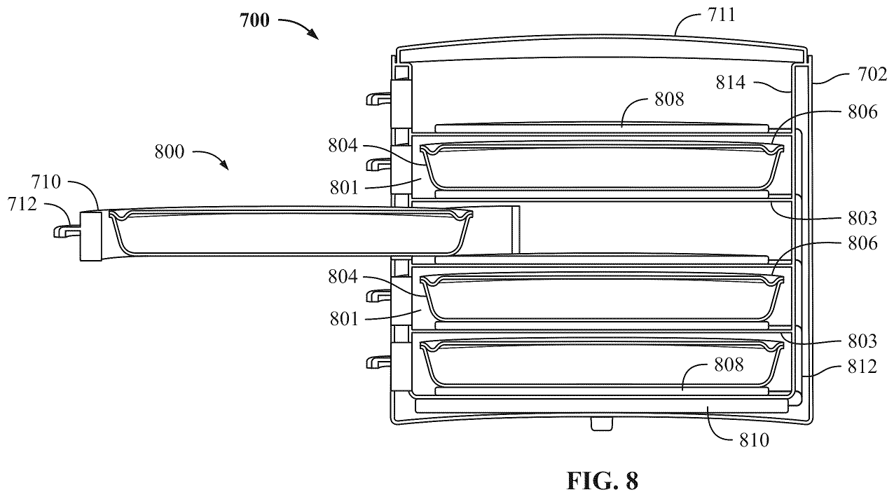

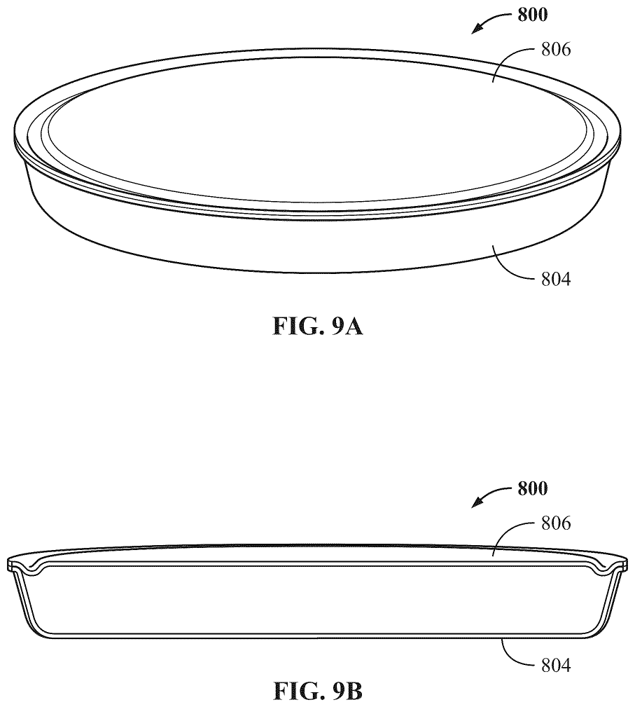

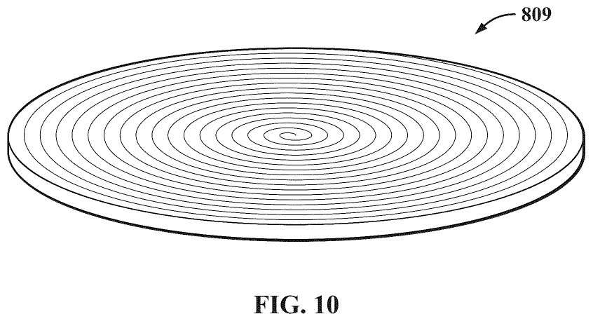

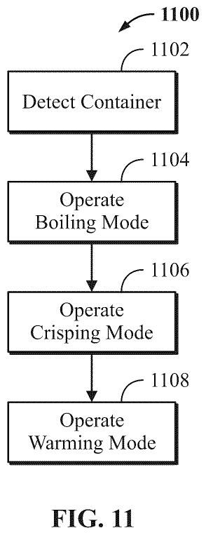

Referring now to the figures, a multi-level crispy rice maker and a method of using thereof is disclosed. FIGS. 1A-B show the outer structure of one example of the multi-level crispy rice maker 100 where the device has an outer shell body 102 with a top opening having an outer lid 110, where stackable containers may be inserted in the body of the device using such opening. FIGS. 2A-B show the inside of the multi-level crispy rice maker 100 and how the stackable containers 200 can stack on top of each other in the center cavity of the device and in between a plurality of inductive coil rings 108. FIGS. 3A-B show the different components of the stackable containers 200, and FIG. 4 shows the whole component of an exemplary inductive coil ring 208 used in the multi-level crispy rice cooker 100 of FIGS. 1 and 2A-2B. As shown in FIGS. 5A-C, the stackable containers 200 may come in different depths 502a-c. As shown in FIG. 6, the relation of the different electrical components (including analog and digital electronics) that different examples and embodiments of multi-level crispy rice makers may share are shown. FIGS. 7A-B show the outer structure of another example of the multi-level crispy rice maker 700 where the device has an outer shell body 702 with a plurality of side openings where slidable containers 800 may slide inwards and outwards from the interior of the device. FIG. 8 shows the inside of the multi-level crispy rice maker 700 and how the slidable containers 800 are orientated in the cavity levels 801 of the device. FIGS. 9A-B show the different structural components of the slidable container 800. FIG. 10 shows an inductive coil that is disk-shaped and part of the heating mechanism 808 of each cavity level 801 shown in FIG. 8. FIG. 11 shows a block diagram of a method to use the multi-level crispy rice maker to make crispy rice.

Although the different embodiments of the multi-level crispy rice maker 100, 700 are mainly described throughout the written description with respect to crisping rice (e.g., tahdig made from basmati rice), it is also contemplated herein that such device may be used to make a crispy layer of other foods, such as potatoes, breads (e.g., lavash bread), pastas, or a combination thereof. The multi-level crispy rice maker may also be used for functions other than crisping food, such as making stews, soups, or other types of meals. By way of example and not limitation, some of the levels of the device may be used for crisping food while other levels may be used for making other foods, such as a stew, so that the user may prepare a complete meal using the device.

Although the different embodiments of the multi-level crispy rice maker 100, 700 are mainly described throughout the written description using inductive coils 208, 809 (see FIGS. 4 and 10) as the heating mechanism, other heating structures are contemplated herein also. By way of example and not limitation, the inductive coils 208, 809 may be replaced by resistive heating elements having the same structural shapes and dimensions shown in FIGS. 4 and 10 for the inductive coils 208, 809. By way of example and not limitation, the resistive heating elements may heat the containers within the multi-level crispy rice maker 100, 700 by converting electric current into heat using resistive material, such as metallic alloys, ceramic materials, or ceramic metals.

Referring specifically now to FIGS. 1A-B, a perspective and a front view of one example of a multi-level crispy rice maker 100 are shown. By way of example and not limitation, the multi-level crispy rice maker 100 may have an outer shell body 102 in the form of a hollow cylinder having a circular opening on top of such body where an outer lid 110 may be placed on top of such opening. By way of example and not limitation, the outer lid 110 may have a lid handle 112 to provide a gripping structure when opening and closing the lid and accessing the inside of the outer shell body 102. Other shapes of the outer shell body 102, such as a cuboid shape (e.g., rectangular prism) or cubic shape, are also contemplated herein. By way of example and not limitation, the outer shell body 102, outer lid 110, and lid handle 112 may be made from a heat-resistive material. By way of example and not limitation, the outer shell body 102 may be made from a rigid polymer material, ceramic material, composite material, or a metal alloy (e.g., aluminum or titanium). By way of example and not limitation, the outer lid 110 and the lid handle 112 may be made from the same material as the outer shell body 102 or may be made from different materials, described elsewhere herein.

The outer shell body 102 may hold stackable containers 200 (see FIG. 2A), heating devices 208, electrical wiring 212, printed circuit board assembly 210, and sensors within its body. By way of example and not limitation, a power cord 116 connected to other electrical components of the device and the printed circuit board assembly 210 within the outer shell body 102 may extend out of such body to be plugged in a power supply. By way of example and not limitation, the outer shell body 102 may have a plurality of legs 114 on an outer surface opposite to the top opening for stabilizing the placement of the multi-level crispy rice maker 100 on a resting surface, such as a kitchen countertop.

By way of example and not limitation, the multi-level crispy rice maker 100 may have a user interface 104 for operating such device. The user interface 104 may be the same as the control panel 604 in FIG. 6 that is electrically connected to the processor 602 of the device. By way of example and not limitation, the user interface 104, and thus the control panel 604, may have an interface display 106 and an adjusting mechanism 108. By way of example and not limitation, the interface display 106 may be in the form of a digital display that displays which heating mechanisms (e.g., inductive coils) are turned on, what heating temperature and/or power each heating mechanisms are adjusted to, and display timers keeping track of how long the heating mechanisms should operate. By way of example and not limitation, the adjusting mechanism 108 may be in the form of a rotating knob or any other adjuster structure. By way of example and not limitation, the interface display 106 and the adjusting mechanism 108 may be one component altogether, such as a touch screen.

By way of example and not limitation, the adjusting mechanism 108 and interface display 106 may be used for turning on and off the multi-level crispy rice maker 100, performing the automatic turning on the correct heating mechanisms, adjusting the heating temperatures of the heating mechanisms (e.g., inductive coils) by directly setting such heating temperature or the amount of power to be applied to the inductive coils, and adjusting the duration of time the heating mechanisms are turned on. Although it is contemplated herein that the turning on and off of the correct set of heating mechanisms may be automated, based on whether the heating mechanisms pick up the presence of a compatible stackable container, such turning on and off may also be operated manually using the user interface 104. By way of example and not limitation, the interface display 106 may also display preset configurations selectable using the adjusting mechanism 108. By way of example and not limitation, the preset configurations may take into account what type of food (e.g., different types of rice, potatoes, breads, pastas, stews, soups, etc.) are about to be cooked by the multi-level crispy rice maker 100. By way of example and not limitation, the preset configurations may also take into account how crispy the food should be cooked, such as being mildly, moderately, or highly crispy.

By way of example and not limitation, the multi-level crispy rice maker 100 may also be operated by a mobile device 612 (see FIG. 6) that is separate from the cooking device. By way of example and not limitation, the mobile device 612 may be connected to the multi-level crispy rice maker 100, and the processor 602, by a transceiver integrated with the control panel 604 (i.e., the user interface 104 of FIG. 1A). Alternatively, the mobile device 612 may be connected to the processor 602 via a transceiver unit. By way of example and not limitation, the mobile device 612 may be connected to the multi-level crispy rice maker 100 via Bluetooth, Wi-Fi, or physical wiring (e.g., a USB cable). By way of example and not limitation, the mobile device 612 may have a software application that a user may interact with to execute the commands and functions, described elsewhere herein, pertaining to the operating the multi-level crispy rice maker 100. Consequently, the mobile device 612 may be an alternate way to operate the multi-level crispy rice maker 100 with respect to the user interface 104. By way of example and not limitation, the mobile device 612 may be a smartphone, tablet, laptop, or other computer device. By way of example and not limitation, the interface display 106 of the user interface 104, shown in FIG. 1A, may display the functions executed by the mobile device 612.

Referring now to FIG. 2A, a cross-sectional view of the multi-level crispy rice maker 100 of FIG. 1A is shown. FIG. 2A further shows the outer shell body 102 containing an inner wall 214, inductive coil rings 208, and electrical wirings 212. By way of example and not limitation, the inductive coil rings 208 and the electrical wirings 212 may be between the outer shell body 102 and the inner wall 214 of the multi-level crispy rice maker 100. By way of example and not limitation, the heating mechanisms of the multi-level crispy rice maker 100 may be a plurality of inductive coil rings 208 that are sandwiched between the outer shell body 102 and the inner wall 214. By way of example and not limitation, the inner wall 214 may be cylindrical having a center cavity therebetween for the stackable containers 200 to be positioned inside the multi-level crispy rice maker 100. By way of example and not limitation, the inner wall 214 may have a bottom surface where most of the electrical circuitry of the device (e.g., printed circuit board assembly and other circuitry) is stored under such surface. By way of example and not limitation, the top portion of the inner wall 214 may form a recess for receiving the outer lid 110. By way of example and not limitation, the inner wall 214 may be made from a heat-resistive material and a non-magnetic material, such as a heat-resistive polymer material, ceramics, or glass-ceramic sheets. Such material may be required since the stackable containers are heated primarily through induction and the inner wall may need to minimize being overheated. By way of example and not limitation, the inner wall may be made from an aluminum alloy.

By way of example and not limitation, each inductive coil ring 208 may be made from closely packed copper wire and have the shape of a circular ring that encircles around a center cavity, defined by the inner wall 214, for the stackable containers 200. By way of example and not limitation, there may be between two to 12 inductive coil rings stacked on top of each other to heat the stackable containers 200. By way of example and not limitation, each inductive coil ring may have a height thickness that is the same height, shorter, or longer, than the height of a stackable container 200. If the height thickness of the inductive coil is the same height or longer than the height of the stackable container 200, then the stackable container 200 and the food contained within it may be heated evenly along its height. If the height thickness of the inductive coil is shorter than the height of the stackable container 200, then only the bottom height portion of the stackable container 200 may directly be heated and the top height portion of the stackable container 200 may not be directly heated. In the aforementioned example, heat from the bottom height portion may ultimately be received to the food inside the container and even to the top height portion. As shown in other figures, and by way of example and not limitation, more than one inductive coil ring 208 may be used to evenly heat the entire height of the stackable container 200, where each coil has a smaller thickness height than the height of the stackable container 200. An isolated illustration of an example of an inductive coil ring 208 used as a heating mechanism for the multi-level crispy rice maker 100 is shown in FIG. 4.

As shown in FIG. 2A, each inductive coil ring 208 of the plurality of inductive coils may be connected to the main electric circuitry and printed circuit board assembly 210 of the device by one or more electrical wiring 212. By way of example and not limitation, the main printed circuit board assembly 210 of the multi-level crispy rice maker 100 may have one or more processors 602 (see FIG. 6), such as a central processing unit, and one or more memory units 606 to execute the operations done by the device. As shown in FIG. 6, the induction coils 608, which may be the same as the inductive coil rings 208, may be electrically connected to the one or more processors 602 of the device. By way of example and not limitation, the one or more operations done by the processor 602 of the multi-level crispy rice maker 100 may be automatically determining which inductive coil rings 208 (see FIG. 2A) should turn on to heat their respective stackable container 200, providing the correct amount of power in reaching the desired heating temperature of the stackable containers 200, keeping track of the heating duration time, operating user selectable preset configurations, tracking sensor readings, and performing emergency shutting down of the device.

By way of example and not limitation, the multi-level crispy rice maker 100 may automatically determine which inductive coil rings 208 need to turn on to heat their respective stackable containers 200. By way of example and not limitation, the processor 602 (see FIG. 6) may execute a command sent to each, or some, inductive coil rings 208 for such components to slightly activate to create radio frequency currents that create magnetic fields. If a compatible stackable container 200 is in the correct position relative to the inductive coil ring 208 that is generating a magnetic field, then an eddy current would be generated within the body of the stackable container 200 proximate to the inductive coil ring 208. The inductive coil ring 208 may detect the generated eddy current and relay to the processor 602 that a compatible stackable container 200 is in the correct position relative to the inductive coil. By way of example and not limitation, a correct position of the stackable container 200 relative to the inductive coil ring 208 may be when the stackable container 200 is placed in the middle of such coil ring such that approximately all of the height of the inductive coil ring 208 overlaps with the height of the stackable container 200. The processor 602 may then execute a command to provide the necessary power to the inductive coil ring 208 to heat the stackable container 200 to the desired temperature.

By way of example and not limitation, a compatible stackable container 200 may be one that is magnetic, such as one that is made from ferrous metal (e.g., having at least some iron material). If the inductive coil ring 208 generating the magnetic field does not detect an eddy current, or detects one that is lower or higher than what is expected from a compatible stackable container 200, then the inductive coil ring 208 may relay to the processor 602 such lack of sufficient current so that the processor 602 does not turn on the inductive coil ring 208. By way of example and not limitation, the processor 602 may display or indicate on the user interface 104 (i.e., control panel 604 of FIG. 6) which inductive coil rings 208 are turned on for heating and which ones are not. By way of example and not limitation, the processor 602 may display on the user interface 104 (i.e., control panel 604 of FIG. 6) one or more error messages if a lower or higher amount of eddy current than expected is detected by an inductive coil ring 208. Since the stackable containers 200 are stacked on top of each other in the device, as shown in FIG. 2A, the inductive coil rings 208 surrounding the lower portion of the center cavity would have to naturally turn on first, and the inductive coil rings 208 surrounding the top portion of the center cavity may or may not turn on depending whether a stackable container 200 is stacked at such height.

By way of example and not limitation, one or more sensors 610 (see FIG. 6) configured for managing the operation of the multi-layer crispy rice maker 100 may be connected to the printed circuit board assembly 210 of FIG. 2A, specifically the processor 602. By way of example and not limitation, the multi-layer crispy rice maker 100 may have one or more temperature sensors to monitor the temperature of stackable containers and to ensure that such containers do not overheat. Consequently, the temperature sensors may be proximate and inside the inner wall 214, shown in FIG. 2A. By way of example and not limitation, the temperature sensors may be coupled to the stackable containers 200 to read the temperature inside the containers. By way of example and not limitation, the multi-layer crispy rice maker 100 may have one or more pressure sensors to monitor the pressure inside of each of the stackable containers 200 and to ensure that large pressure does not build up in the stackable containers 200 that would cause the container to burst open. Consequently, the pressure sensors may be coupled to the stackable containers 200. Alternatively, the pressure sensors may be proximate and inside the inner wall 214 to monitor the pressure build-up within the cavity defined by the inner wall 214 of the multi-layer crispy rice maker 100. By way of example and not limitation, a safety switch may also be connected to the main electric circuitry and printed circuit board assembly 210 such that the safety switch is designed to shut off the multi-level crispy rice maker 100 if the temperature sensor or pressure sensor (embodied by the sensors 610 in FIG. 6) detect a hazardous temperature or pressure, respectively, of the stackable containers 200 and the device in general.

Referring now to FIGS. 3A-B, and by way of example and not limitation, the stackable container 200 may have a cylindrical disk shape with a container cavity that may have a shallow depth or a deep depth (see FIGS. 5B-C). Other shapes of the stackable containers 200, such as rectangular, triangular, or trapezoidal is also contemplated herein. Since the rice that is close to and contacting the bottom surface of the stackable container 200 is usually the portion that is crispened, the shallow depth of the stackable containers 200 may be preferred to allow for more stackable containers 200 to be stacked on top of each other. By way of example and not limitation, the multi-level crispy rice maker 100 may hold between two to ten stackable containers 200 within its center cavity that is surrounded by inductive coil rings 208 (see FIG. 2A). Referring back to FIG. 3B, and by way of example and not limitation, the stackable container 200 may have an inner segment 204, an outer segment 202, and a container lid 206.

By way of example and not limitation, the inner segment 204 may be secured to the outer segment 202 or may be removably detachable. By way of example and not limitation, the inner segment 204 may be a layer of food-safe material designed to contact and cook the food inside the stackable container 200. By way of example and not limitation, the inner segment 204 may be thinner than the outer segment 202 and be laid on top of thereof. Consequently, the inner segment 204 may have a cylindrical disk shape with a container cavity surrounded by walls of the disk shape and a bottom surface. Other shapes of the inner segment, such as rectangular, triangular, or trapezoidal are also contemplated herein. By way of example and not limitation, the inner segment 204 may also have outer lips that are designed to rest on top of the outer edges of the outer segment 202 for better binding between the two components.

By way of example and not limitation, the inner segment 204 may be made from a metallic, ceramic, composite, or rigid polymer material. By way of example and not limitation, the metallic material may be of ferrous material (e.g., steel, stainless, steel, or cast iron) or may be made from an aluminum or copper material. By way of example and not limitation, the inner segment 204 may be made of a material that is more heat conductive than the outer segment 202 so that when the outer segment 202 is heated by induction via the inductive coil rings 208 (see FIG. 2A), such heating is transferred faster to the inner segment 204 than if the inner segment 204 and the outer segment 202 were made from the same material. By way of example and not limitation, the inside surface of the inner segment 204 may be a non-stick surface (e.g., coated with polytetrafluoroethylene) to prevent the crispy rice from getting stuck to the inner segment 204.

By way of example and not limitation, the outer segment 202 may have a cylindrical disk shape with a container cavity surrounded by walls of the disk shape and a bottom surface, where the container cavity of the outer segment 202 is configured to receive the inner segment 204. By way of example and not limitation, the inner segment 204 may be secured or detachable from the outer segment 202. Other shapes of the outer segment 202, such as rectangular, triangular, or trapezoidal are also contemplated herein. By way of example and not limitation, the outer segment 202 may have a greater body thickness profile than the inner segment 204. By way of example and not limitation, the outer segment 202 may be made from a ferrous material containing iron material (e.g., steel, stainless steel, or cast iron) in order to be heated by the inductive coil ring 208 via induction heating.

As shown in FIG. 2B, and by way of example and not limitation, the bottom of the outer segment 202b may be made from a different material than the walls of the outer segment 202a. By way of example and not limitation, the bottom of the outer segment 202b may be made from a more heat conductive material than the walls of the outer segment 202a. This may be needed to allow an even heat distribution throughout the outer segment 202, and the stackable container 200 in general, since the inductive coils 208 mostly directly heat the walls of the outer segment 202a. As such, heat may be distributed throughout the bottom of the outer segment 202b at a similar rate as heat is generated and distributed throughout the walls of the outer segment 202a, especially if the bottom of the outer segment 202b is made from a more heat conductive material than the walls of the outer segment 202a. By way of example and not limitation, the outer segment 202 may have a bottom module 202b and a wall module 202a combined together. By way of example and not limitation, such modules may be made from similar metallic alloys or may be made from different materials, such as different metal materials.

As shown in FIGS. 2A-B, and by way of example and not limitation, the outer segment 202 may be filled and continuous throughout its body thickness. As shown in FIGS. 5A-C, and by way of example and not limitation, the outer segment 202 may have a hollow thickness throughout its body, where the body of the outer segment 202 is defined by outer layers enclosing the hollow thickness. By way of example and not limitation, the outer layer portion of the hollow outer segment 202 proximate to the inner segment 204 of the stackable container 200, as shown in FIGS. 5A-C, may merge with the inner segment 204 or may be separate but couple with the inner segment 204. The hollow thickness of the outer segment 202 may allow for the gradual heating of the stackable container 202 and the inner segment 204 such that the food inside the container is also gradually heated. On the other hand, the filled thickness of the outer segment 202 may increase heat distribution within the body of the stackable container 200 and the inner segment 204 such that the food inside the container reaches the needed heating temperature faster.

Referring back to FIG. 2A, and by way of example and not limitation, each stackable container 200 may have a container lid 206. By way of example and not limitation, the container lid 206 may be disk-shaped having an indentation circle proximate to the outer edges of the disk. Other shapes of the container lid 206, such as rectangular, triangular, or trapezoidal are also contemplated herein. By way of example and not limitation, the container lid 206 may be removably attached to the inner segment 204 and outer segment 202. By way of example and not limitation, the container lid 206 may latch to the inner segment 204, specifically the outer lips of the inner segment 204. By way of example and not limitation, the container lid 206 may latch to the outer segment 202, specifically the outer edges of the wall of the outer segment 202.

By way of example and not limitation, when the container lid 206 is latched to the inner segment 204 and/or the outer segment 202, the stackable container 200 may be pulled out of the center cavity of the multi-layer crispy rice maker 100 using the container lid 206. By way of example and not limitation, the container lid 206 may have a receiver structure, or opening, allowing a user to insert a utensil, such as a fork, in the receiver structure or opening to hook out the stackable container 200 out of the center cavity of the device. By way of example and not limitation, the receiver structure, or opening, may also act as a ventilation and depressurizing structure. By way of example and not limitation, if the container lid 206 is merely removably attached to the rest of the body of the stackable container 200 without latching, then one or more receiver structures or openings may be on the outer walls of the outer segment 202 for a user to insert one or more utensils, such as forks, in the receiver structure, or openings, to hook out the stackable container 200 out of the center cavity of the device. By way of example and not limitation, the receiver structures, or openings, on the outer segments may also act as ventilation and depressurizing structures.

As shown in FIG. 2A, and by way of example and not limitation, each stackable container 200 may be stacked on top of the container lid 206 of a bottom stackable container 200. Alternatively, the bottom stackable containers 200 may not have container lids 206 and the bottom portion of the stackable container 200 directly on top of the bottom stackable container 200 may act as a container lid for such bottom stackable container 200. As a result, only the very top stackable container 200 may need a container lid 206. In some examples, the very top stackable container may also not need a container lid 206 since the outer lid 110 encloses the top of container cavity and the stackable containers 200. By way of example and not limitation, each container lid 206 may have ventilation holes to allow steam to escape the inside of the container when cooking crispy rice, for example.

By way of example and not limitation, the container lids 206 may be made from the same or different materials, described elsewhere herein. By way of example and not limitation, the container lid 206 may be ferrous, non-ferrous, non-metallic, or heat resistive as the material described elsewhere herein with other structures of the multi-layer crispy rice maker 100.

As shown in FIGS. 5A-C, and by way of example and not limitation, the stackable containers 200 may come in different depths 502a-c. FIG. 5B shows how the stackable containers 200 may come in shallow depth 502a, medium depth 502b, and deep depth 502c, where the depth is measured from the top edge of the inner segment 204 to the bottom inner surface of the inner segment 204. The usage of more shallow depth stackable containers 200 (see FIG. 5A), may allow for the cooking of more crispy rice since there exists more bottom surface area in the device for the rice to get crispy on. The usage of the medium and deep depth 502b-c stackable containers 200 may allow for the cooking of other types of food, such as stews and soups, where more container volume is needed per container, and such volume may be essential instead of the amount of total bottom surface area for crisping rice. By way of example and not limitation, each shallow depth 502a stackable container 200 may be centered between only one inductive coil ring 208 for heating, where the medium and deep depth 502b-c stackable containers 200 may be centered between more than one inductive coil rings 208, if the inductive coil rings 208 all have the same height. Alternatively, the inductive coil rings 208 may come in different heights that are similar to the depth distances 502a-c of the stackable containers 200 that they are supposed to heat.

Referring now to FIGS. 7A-B, a perspective and a front view of another embodiment of a multi-level crispy rice maker 700 are shown. In this embodiment of the multi-level crispy rice maker, the cooking containers are horizontally slidable out of the inside of the outer shell body 702 of the multi-level crispy rice maker 700 rather than being stacked on top of each other. Consequently, each slidable container 800 may be placed on top of a heating mechanism inside the outer shell body 702 of the multi-level crispy rice maker. Although the following embodiment of the crispy rice maker 700 shows the slidable containers 800 sliding in and out of the outer shell body 702, it is also contemplated herein that the slidable container 800 may be pivotable containers. By way of example and not limitation, the containers holding the food to be cooked by the multi-level crispy rice maker 700 may pivot in and out of the cavity levels 801 of the outer shell body 702. By way of example and not limitation, the outer casing 710 of the containers may be hinged to the outer shell body 702 for each container to pivot open and closed about a rotational axis about the hinges coupled to the outer casing 710 and the container.

By way of example and not limitation, the outer shell body 702 of the crispy rice maker 700 may be cylindrical having a top and bottom enclosure surface and a plurality of outer casings 710 therebetween that are orientated above each other. Other shapes of the outer shell body 702, such as cuboid shape (e.g., rectangular prism) or cubic shape, are also contemplated herein. By way of example and not limitation, the outer shell body 702 may hold slidable containers 800, heating devices 808, electrical wiring 812 (see FIG. 8), main circuitry and printed circuit board assembly 810, and sensors within its body. By way of example and not limitation, each slidable container 800 may be attached to an outer casing 710 used for sliding the slidable container 800 inwards and outwards from the inside of the outer shell 702. By way of example and not limitation, a power cord 716 electrically connected to the main circuitry and printed circuit board assembly 810 within the outer shell 702 may extend out of such body to be plugged to a power supply. By way of example and not limitation, the outer shell body 702 may have a plurality of legs on the bottom enclosure surface of the outer shell for stabilizing the placement of the multi-level crispy rice maker 700 on a resting surface, such as a kitchen countertop. By way of example and not limitation, the outer shell body 702 may be made from a heat-resistive material. By way of example and not limitation, the outer shell body 702 may be made from a rigid polymer material, ceramic, composite material, or metal alloy (e.g., aluminum).

By way of example and not limitation, each outer casing 710 may be part of the outer shell body 702 and lay flush with the rest of the body of the outer shell when the outer casings 710 are slid inward and in closed positions. Consequently, each outer casing 710 may have a curved shape making up a portion of the cylindrical body of the outer shell body 702. By way of example and not limitation, each outer casing 710 may have a casing handle 712 configured for a user to use as a gripping structure for sliding the slidable container 800 inwards and outwards. By way of example and not limitation, each outer casing 710 may be secured or removably attached to each slidable container 800. By way of example and not limitation, the outer casings may be made from the same or different material as the outer shell body 702, as described elsewhere herein.

By way of example and not limitation, the multi-level crispy rice maker 700 may have a user interface 704 for operating such device. The user interface 704 may be the same as the control panel 604 in FIG. 6 that is electrically connected to the processor 602 of the device. By way of example and not limitation, the user interface 704, and thus the control panel 604, may have an interface display 706 and an adjusting mechanism 708. By way of example and not limitation, the interface display 706 may be in the form of a digital display that displays which heating mechanisms (e.g., inductive coils) are turned on, what heating temperature and/or power each heating mechanisms are adjusted to, and display timers keeping track of how long the heating mechanisms should operate. By way of example and not limitation, the adjusting mechanism 708 may be in the form of a rotating knob or any other adjuster structure. By way of example and not limitation, the interface display 706 and the adjusting mechanism 708 may be one component altogether, such as a touch screen.

By way of example and not limitation, the adjusting mechanism 708 and interface display 706 may be used for turning on and off the multi-level crispy rice maker 700, performing the automatic turning on of the correct heating mechanisms, adjusting the heating temperatures of the heating mechanisms (e.g., inductive coils) by directly setting such heating temperature or the amount of power to be applied to the inductive coils, and adjusting the duration of time the heating mechanisms are turned on. Although it is contemplated herein that the turning on and off of the correct set of heating mechanisms may be automated, based on whether the heating mechanisms pick up the presence of a compatible slidable container, such turning on and off may also be operated manually using the user interface 704. By way of example and not limitation, the interface display 706 may also display preset configurations selectable using the adjusting mechanism 708. By way of example and not limitation, the preset configurations may take into account what type of food (e.g., different types of rice, potatoes, breads, pastas, stews, soups, etc.) are about to be cooked by the multi-level crispy rice maker 700. By way of example and not limitation, the preset configurations may also take into account how crispy the food should be cooked, such as being mildly, moderately, or highly crispy.

By way of example and not limitation, the multi-level crispy rice maker 700 may also be operated by a mobile device 612 (see FIG. 6) that is separate from the cooking device. By way of example and not limitation, the mobile device 612 may be connected to the multi-level crispy rice maker 700, and the processor 602, by a transceiver integrated with the control panel 604 (i.e., the user interface 704 of FIG. 7). Alternatively, the mobile device 612 may be connected to the processor 602 via a transceiver unit. By way of example and not limitation, the mobile device 612 may be connected to the multi-level crispy rice maker 700 via Bluetooth, Wi-Fi, or physical wiring (e.g., a USB cable). By way of example and not limitation, the mobile device 612 may have a software application that a user may interact with to execute the commands and functions, described elsewhere herein, pertaining to the operating the multi-level crispy rice maker 700. Consequently, the mobile device 612 may be an alternate way to operate the multi-level crispy rice maker 700 with respect to the user interface 704. By way of example and not limitation, the mobile device 612 may be a smartphone, tablet, laptop, or other computer device. By way of example and not limitation, the interface display 706 of the user interface 704, shown in FIG. 7, may display the functions executed by the mobile device 612.

As shown in FIG. 8, and by way of example and not limitation, the inside of the outer shell body 702 of the multi-level crispy rice maker 700 may be compartmentalized by different levels 801, each level having a cavity for holding a slidable container 800 that rests on top of a heating structure 808 having a disk-shaped inductive coil 809 (see FIG. 10). By way of example and not limitation, the multi-level crispy rice maker may have between two to ten cavity levels 801. By way of example and not limitation, an outer edge of each cavity level 801 may be between the inner surface of the outer casing 710 (see FIG. 7B) and an inner wall 814 opposite to the outer casting 710. By way of example and not limitation, the outer casing 710 may be configured to attach to the slidable container 800 that is inserted in the cavity level 801. By way of example and not limitation, the cavity levels 801 may be divided from each other by horizontal dividers 803. A horizontal divider 803 may act as a bottom support surface (e.g., the floor) for a heating structure 808, and also the slidable container 800, of a first cavity level 801 and a top surface (e.g., the ceiling) for a second cavity level 801 directly below the first cavity level. By way of example and not limitation, one or more electrical wiring 812 may extend between the inner wall 814 of the cavity levels 801 and the outer shell body 702 to electrically connect the inductive coil disks 809 (see FIG. 10) of the heating structures 808 to the main electric circuitry and PCB assembly 810 of the device that is situated under the cavity levels 801.

Referring back to FIG. 8, and by way of example and not limitation, each heating structure 808 may have an inductive coil disk 809 (see FIG. 10) within an outer layer. As shown in FIG. 10, and by way of example and not limitation, the inductive coil disk 809 may be made from copper coil wire closely packed together to make a disk shape and a planar surface, in general. The inductive coil disk 809 may create a planar surface having a diameter equal to the diameter or cross-sectional dimension of the bottom of the slidable container 800 (see FIG. 8). The equal dimensions of the diameter of the inductive coil disk 809 and the bottom of the slidable container 800 may be necessary since the inductive coil disk 809 directly heats the material of the slidable container 800 facing and overlapping with the coil via induction heating. By way of example and not limitation, the multi-level crispy rice maker 700 may have between two to ten inductive coil disks 809 and heating structures 808, which may equal the same amount of cavity levels 801 the device may have. By way of example and not limitation, the outer layer of the heating structure 808 enclosing the inductive coil disk 809 in FIG. 8 may be made from a heat-resistive material and a non-magnetic material, such as a heat-resistive polymer material, ceramics, or glass-ceramic sheets. Such material may be necessary since the slidable containers 800 are heated primarily through induction, and the outer layer of the heating structure 808 may be needed to minimize being overheated.

By way of example and not limitation, each inductive coil disk 809 of the heating structures 808 may only heat the slidable container 800 that is resting directly on top of said heating structure 808. Consequently, the distance between a slidable container 800 on a bottom cavity level 801 and the heating structure 808 directly above such cavity level 801 may be large enough to disallow the electrical induction and induction heating of the aforementioned above heating structure 808 from reaching the slidable container 800 of the bottom cavity 801. Alternatively, or additionally, the horizontal dividers 803 may be made of a material that disallows the transmission of electrical induction and induction heating to other cavity levels 801.

By way of example and not limitation, the inductive coil disk 809 above a cavity level 801 in FIG. 8 may heat, via induction, the slidable container 800 of the lower cavity layer in addition to heating the slidable container that is resting on top of the heating structure 808 having the inductive coil disk 809. Consequently, the horizontal dividers 803 may be made of a material that allow for the transmission of induction heating from the heating structure 808 of a top cavity level 801 to the slidable container 800 of the cavity level 801 directly below said top cavity level 801. Alternatively, each cavity level 801 may have two heating structures 808 having inductive coil disks 809, one on bottom and the other on top of each cavity level 801.

As shown in FIG. 8, each heating structure 808, specifically the inductive coil disk 809 shown in FIG. 10, may be connected to the main electric circuitry and printed circuit board assembly 810 of the device by one or more electrical wirings 812. By way of example and not limitation, the main printed circuit board assembly 810 of the multi-level crispy rice maker 700 may have one or more processors 602 (see FIG. 6), such as a central processing unit, and one or more memory units 606 to execute the operations done by the device. As shown in FIG. 6, the induction coils 608, which may be the same as the inductive coil disks 809, may be controllable by one or more processors 602 of the device. By way of example and not limitation, the one or more operations done by the processor 602 of the multi-level crispy rice maker 700 may be automatically determining which heating structures 808 (see FIG. 8) should turn on to heat their respective slidable container 800, providing the correct amount of power in reaching the desired heating temperature of the slidable containers 800, keeping track of the heating duration time, operating user selectable preset configurations, tracking sensor readings, and performing emergency shutting down of the device.

By way of example and not limitation, the multi-level crispy rice maker 700 may automatically determine which inductive coil disks 809 of the heating structures 808 need to turn on to heat their respective slidable containers 800. By way of example and not limitation, the processor 602 (see FIG. 6) may execute a command sent to each, or some, inductive coil disks 809 of the heating structures 808 for such components to slightly activate to create radio frequency currents that create magnetic fields. If a compatible slidable container 800 is in the correct position relative to the inductive coil disk 809 that is generating a magnetic field, then an eddy current would be generated within the body of the slidable container 800 proximate to the inductive coil disk 809. The inductive coil disk 809 may detect the generated eddy current and relay to the processor 602 that a compatible slidable container 800 is in the correct position relative to the inductive coil. By way of example and not limitation, a correct position of the slidable container 800 relative to the inductive coil disk 809 may be when the slidable container 800 is placed on top of such inductive coil disk 809 such that approximately all of the disk surface area of the inductive coil disk 809 overlaps with the bottom of the slidable container 800. The processor 602 may then execute a command to provide the necessary power to the inductive coil disk 809 of the heating structure 808 to heat the slidable container 800 to the desired temperature.

By way of example and not limitation, a compatible slidable container 800 may be one that is magnetic, such as one that is made from ferrous metal (e.g., having at least some iron material). If the inductive coil disk 809 of the heating structure 808 generating the magnetic field does not detect an eddy current, or detects one that is lower or higher than what is expected from a compatible slidable container 800, then the inductive coil disk 809 may relay to the processor 602 such lack of sufficient current so that the processor 602 does not turn on the inductive coil disk 809 of the heating structure 809. By way of example and not limitation, the processor 602 may display or indicate on the user interface 704 (i.e., control panel 604 of FIG. 6) which heating structures 808 are turned on for heating and which ones are not. By way of example and not limitation, the processor 602 may also display or indicate on the user interface 704 which outer casing 710 and slidable container 800 are in a closed position (e.g., slid inwards of the cavity level 801) or open position (e.g., slid outwards of the cavity level 801). By way of example and not limitation, the processor 602 may display on the user interface 704 (i.e., control panel 604 of FIG. 6) one or more error messages if a lower or higher amount of eddy current than expected is detected by an inductive coil disk 809 of a heating structure 808. Since the slidable containers 800 are placed in their own respective cavity level 801 in the device, as shown in FIG. 8, the turning on and off of a specific heating structure 808 may be independent as to the other heating structures 808.

By way of example and not limitation, one or more sensors 610 (see FIG. 6) configured for managing the operation of the multi-layer crispy rice maker 700 may be connected to the printed circuit board assembly 810 of FIG. 8, specifically the processor 602. By way of example and not limitation, the multi-layer crispy rice maker 700 may have one or more temperature sensors to monitor the temperature of slidable containers 800 and to ensure that such containers do not overheat. Consequently, the temperature sensors may be proximate and inside the cavity levels 801, shown in FIG. 8. By way of example and not limitation, the temperature sensors may be coupled to the slidable containers 800 to read the temperature inside the containers. By way of example and not limitation, the multi-layer crispy rice maker 700 may have one or more pressure sensors to monitor the pressure of each of the slidable containers 800 and to ensure that large pressure does not build up in the slidable containers 800 that would cause the container to burst open. Consequently, the pressure sensors may be coupled to the slidable containers 800 to measure the inside pressure of the containers. Alternatively, the pressure sensors may be proximate and inside the cavity levels 801 to measure the pressure build-up within the cavities. By way of example and not limitation, a safety switch may also be connected to the main electric circuitry and printed circuit board assembly 810 such that the safety switch is designed to shut off the multi-level crispy rice maker 700 if the temperature sensor or pressure sensor (embodied by the sensors 610 in FIG. 6) detect a hazardous temperature or pressure, respectively, of the slidable containers 800 and the device in general.

Referring now to FIGS. 9A-B, a perspective and cross-sectional view of a slidable container 800 is shown. By way of example and not limitation, the slidable container 800 may have a container structure 804 and a container lid 806. By way of example and not limitation, the container lid 806 may have a disk shape with a circle indentation around approximately the outer edges of the disk. By way of example and not limitation, the container structure 804 may have a cylindrical disk shape with a container cavity and a top opening surrounded by walls of the disk shape and a bottom surface, where the container cavity may have a shallow or deep depth. Other structural shapes for the slidable containers 800, such as rectangular, triangular, or trapezoidal are also contemplated herein. Since the rice that is close to and contacting the bottom surface of the slidable container 800 is usually the portion that is crispened, the shallow depth of the slidable containers 800 may be preferred to allow for more containers to be utilized with the device. By way of example and not limitation, the device may hold between two to ten slidable containers 800 corresponding to how many cavity levels 801 the multi-level crispy rice maker 700 contains.

By way of example and not limitation, container structure 806 may be one unitary body. Alternatively, the container structure 806 may have an inner segment and an outer segment with the same functions and features described elsewhere herein. By way of example and not limitation, the container structure 804 may have a container cavity with an inner surface that is designed to be food-safe and contact and cook the food inside the slidable container 800. By way of example and not limitation, the inner surface of the container structure 804 may have a non-stick surface coating (e.g., coated with polytetrafluoroethylene) to prevent the crispy rice from getting stuck to the inner surface. By way of example and not limitation, the container structure 804 may also have outer lips that are designed to receive the outer edges of the container lid 806.

By way of example and not limitation, the container structure 804, especially the bottom portion of the container structure 804, may be made from a ferrous material containing iron material (e.g., steel, stainless steel, or cast iron) in order to be heated by the inductive coil disk 809 of the heating structure 808 (see FIGS. 8 and 10) via induction heating. By way of example and not limitation, the bottom portion of the container structure 804 may be made from a more ferrous material than the walls of the container structure 804. By way of example and not limitation, the bottom portion of the container structure 804 may be made from a ferrous material while the wall of the container structure 804 may be made from a non-ferrous material. Consequently, the container structure 804 may be modular having a bottom portion module combined with a wall module. By way of example and not limitation, such modules may be made from similar metallic alloys or may be made from different materials, such as different metal materials.

By way of example and not limitation, each slidable container 800 of FIG. 8 may have a container lid 806. By way of example and not limitation, the container lid 806 may be disk-shaped having an indentation circle proximate to the outer edges of the disk. Other shapes for the container lid 806, such as rectangular, triangular, or trapezoidal are also contemplated herein. By way of example and not limitation, the container lid 806 may be removably attached to the container structure 804. By way of example and not limitation, the container lid 806 may latch to the container structure 804, specifically the outer lips of the container structure 804. By way of example and not limitation, the container lid 806 may have one or more ventilation holes to depressurize the interior of the slidable container 800 while being heated to make crispy rice. By way of example and not limitation, the container lid 806 may be made from the same or different material as the container structure, described elsewhere herein. By way of example and not limitation, the container lid 806 may be made from the same material as the other lids, described elsewhere herein. By way of example and not limitation, the container lid 806 may be made from a ferrous, non-ferrous, or even non-metallic heat-resistive material described elsewhere herein with other structures of the device.

Referring now to FIG. 11, a block diagram of a method 1100 of operating the multi-level crispy rice maker 100, 700 to make crispy rice (e.g., tahdig) is shown. By way of example and not limitation, the method/process 1100 of making crispy rice may be operated by one or more steps, such as detecting a compatible container 1102, boiling 1104 the food content, crisping 1106 the food content, and maintaining the food warm 1108. By way of example and not limitation, there may also exist some intermediate steps that need to be taken in between the blocks shown in FIG. 11 to create the tahdig (e.g., adding additional food content), as described elsewhere herein.

By way of example and not limitation, the modes and steps in creating the crispy rice, such as those shown in FIG. 11 and described elsewhere herein, may be selected using the control panel 604 (e.g., user interface 104, 704) or the mobile device 612 (see FIG. 6) that is part of or connected to the multi-level crispy rice maker 100, 700. Alternatively, one or more of the modes and steps in creating the crispy rice, described elsewhere herein, using the crispy rice maker 100, 700 may be programmed to run autonomously. By way of example and not limitation, the modes and steps shown in FIG. 11 may be executed by the processing unit 602 (see FIG. 6) of the crispy rice maker 100, 700. By way of example and not limitation, the pre-programmed functions of the crispy rice maker 100, 700, described elsewhere herein, may be stored in the memory unit 606 and executed by the processing unit 602 when such functions are selected. In other examples, the processor 602 and/or the memory unit 606 may not be required to execute the method 1100.

Referring back to FIG. 11, and in block 1102, the process detects whether to initialize operation based on detecting one or more compatible containers 200, 800 (see FIGS. 2A and 8). By way of example and not limitation, the detection of a compatible container 200, 800 for usage with the crispy rice maker 100, 700 may be done using the inductive coils and generating eddy current within the containers, as described elsewhere herein. Alternatively, the detection of the compatible container may be done using one or more sensors. By way of example and not limitation, the detection of a compatible container may be done automatically by the crispy rice maker 100, 700 without the user having to input anything to the device, as described elsewhere herein.

In block 1104, the process operates a boiling mode of the crispy rice maker 100, 700. The user may fill containers 200, 800 (see FIGS. 2A and 8) with water, food content (e.g., uncooked basmati rice or uncooked pasta), and seasonings (e.g., salt) and select on the control panel 604 or mobile device 612 (see FIG. 6) the execution of the boiling mode 1104. By way of example and not limitation, the selection of the boiling mode 1104 may be a singular function or part of a combination of functions that may be selected together. By way of example and not limitation, the combination of functions may include some or all of the blocks shown in FIG. 11. By way of example and not limitation, the lids 206, 806 (see FIGS. 2A and 8) of the containers 200, 800 may be needed to create the necessary enclosure for the rice to be properly cooked in the boiling water and steam.

In block 1104, the inductive coils 208, 808 (see FIGS. 2A and 8) may provide heat to the containers 200, 800 to boil the water and cook the uncooked rice therein until the rice has a fluffy and soft texture. Consequently, enough power may be generated by the inductive coils 208, 800 to provide heat to the containers to boil water for cooking the rice. By way of example and not limitation, the boiling mode may use more power when compared to the other modes shown in FIG. 11 and described elsewhere herein.

By way of example and not limitation, the crispy rice maker 100, 700 (e.g., processor 602) may determine the boiling phase should terminate when detecting that less amount of power is being generated to maintain the boiling temperature inside the container, since mostly all of the liquid water has evaporated. By way of example and not limitation, such boiling temperature may be between 100-102 degrees Celsius at sea-level, depending on the amount of salt added to the water for seasoning. By way of example and not limitation, the temperature inside of the one or more containers 200, 800 may be measured by the temperature sensors represented by sensors 610 in FIG. 6, and described elsewhere herein. Alternatively, the boiling phase may terminate based on a user inputted time interval, where the crispy rice maker 100, 700 may help the user determine the time interval based on information provided by the user (e.g., amount of water, rice, and seasoning added and type of rice). By way of example and not limitation, the time to reach the boiling temperature of the water and food content inside the one or more containers 200, 800 from room temperature (e.g., 20-23 degrees Celsius) may take 1.5 to 5 minutes using the inductive heating of the device.

Upon the reaching of boiling temperature and also the termination of the boiling mode 1104 (since the rice inside is cooked), by way of example and not limitation, the control panel 604 and/or the mobile device 612 may display an indication of achieving such events independent from each other. By way of example and not limitation, a user may use the control panel 604 or the mobile device 612 to input information about what is being added (e.g., type of rice or pasta, amount of water, rice, and seasoning) inside the containers 200, 800 prior to the execution of the boiling mode for the processor 602 to determine to execute a pre-programmed function/calculation when boiling the food in block 1104. The pre-programmed function may change the amount of power being supplied as heat to the containers 200, 700 and the boiling duration, depending on the inputted information.

In block 1106 of FIG. 11, the process operates the crisping mode of the crispy rice maker 100, 700. By way of example and not limitation, the crisping mode may operate consecutively right after the boiling mode of block 1104, or the crisping mode may operate after a pause between the two modes. For making tahdig, the basmati rice may need to be emptied out of the container 200, 800 to add at least some oil or fat to the inner bottom surface (and possibly lower sides) of the container to make the necessary texture and taste of the tahdig. Before operating the crisping mode, the user may also want to add other food ingredients, such as potatoes, lavash bread, or pasta to the inner bottom surface of the container with different seasonings and garnishes (such as saffron water, yogurt, and nuts) to make the tahdig tastier. Also, the user may want to poke ventilation holes in the mound of rice for the steam from the bottom of the mound, having the crispy surface, from escaping. Consequently, the process may pause between block 1104 and 1106 for a user to add the needed and desired ingredients inside the containers 200, 800 to make a tahdig. Alternatively, and by way of example and not limitation, the process may run consecutively between blocks 1104 and 1106 when detecting that less power is being applied as heat to the containers 200, 800 to maintain the boiling temperature.

In another example, block 1106 may function without block 1104 if the user inserts parboiled rice in the container 200, 800 for crisping. The user may still need to add at least some oil to the bottom inner surface of the container 200, 800 to achieve the desired taste and texture of tahdig. As described elsewhere herein, the user may input to the crispy rice maker 100, 700, using control panel 604 or mobile device 612, the usage of parboiled rice for the device to calibrate to cook such rice (e.g., adjustment of heat as power input and duration of crisping).

In block 1106, and by way of example and not limitation, the power supplied as heat to the containers 200, 800 by the inductive coils 208, 808 may be less than the power supplied in block 1104 (i.e., boiling mode), but greater than the power supplied in block 1108 (i.e., warming mode). This may be due to the device not needing to boil water and may also maintain a lower temperature than the boiling temperature of water for crisping the rice that is contacting the bottom surface of the container 200, 800. The crisping temperature may still be higher than the temperature used in warming mode to keep the food at a desired temperature for eating. For crisping the rice contacting the bottom surface of the container 200, 800 to make the tahdig, by way of example and not limitation, less heat and temperature but more time may be required (when compared to the boiling mode) to achieve the crispiness. In block 1106, and by way of example and not limitation, the inductive coils of the device may supply heat to the containers 200, 800 to maintain a temperature in the range of 70 to 100 degrees Celsius for 25 to 60 minutes, depending on how crispy the tahdig should be. The specific time and temperature may also depend on the type of food content used to make tahdig in block 1106, which such specific time and temperature may be pre-programmed, calculated, and selectable using control panel 604 or mobile device 612 (see FIG. 6). The temperature sensors of the device represented by sensors 610 (see FIG. 6), described elsewhere herein, may monitor the temperature inside the containers 200, 800 in the crisping mode. By way of example and not limitation, the heat generation by the inductive coils may vary throughout the crisping mode to achieve different temperatures for the crisping of tahdig. For example, the heat generation and temperature may be relatively higher in the beginning of the crisping mode when compared towards its end, or vice versa.

By way of example and not limitation, the user may select on the control panel 604 or mobile device 612 the food content used to make tahdig in block 1106 (such as if and what additional food content were added for crisping), and also select how crispy the tahdig should be. The food content may be just the rice, or the added oil and other foods to the bottom surface of the container 200, 800, described elsewhere herein. By way of example and not limitation, the device may display on the control panel 604 or mobile device 612 recommended crisping temperatures and time durations depending on the type of food content in the tahdig (e.g., usage of other food such as potatoes or breads).

By way of example and not limitation, the crispy levels achieved in block 1106 may be categorized or selected on a color spectrum. By way of example and not limitation, the user may select to have the tahdig to be mildly, medium, or heavily crisped, and the device (e.g., processor of device) may select the time and temperature range, described elsewhere herein, while also taking into account the food content. By way of example and not limitation, some of the containers 200, 800 may operate at a different crisping level than the other containers. For example, some of the containers 200, 800 of the multi-level crispy rice maker 100, 700 may make mildly crisped tahdig, some may make medium crisped tahdig, and some may make heavily crisped tahdig. Alternatively, all of the containers 200, 800 may make the same level of crispy tahdig.

In another example, the user may use the control panel 604 or mobile device 612 to select what color the tahdig should come out, which a lighter color may correspond to a less crispy tahdig (e.g., light yellow) and a darker color (e.g., golden brown) may correspond to a more crispy tahdig. By way of example and not limitation, the color range of the tahdig may include, light yellow, yellow, gold, golden brown, and brown. By way of example and not limitation, the device (e.g., processor of device) may calibrate the time and temperature range corresponding to the selected tahdig color, described elsewhere herein, while also taking into account the food content, which may be inputted by the user to the device. By way of example and not limitation, some of the containers of the device may make one colored tahdig and others may make a different colored tahdig, as described elsewhere herein. Alternatively, the user may input into the device a time duration for the crisping mode to operate and make the tahdig and the desired crispiness.

In block 1108, the process may keep the food warm inside the crispy rice maker 100, 700 at a desired temperature, after the tahdig is formed and for the user to serve the dish warm. By way of example and not limitation, the warming temperature created by the crispy rice maker (specifically the inductive coils) to maintain the food content inside the containers warm may range between 60 to 70 degrees Celsius. Consequently, less power may be supplied in the warming mode than in the crisping mode since a lower temperature needs to be maintained. By way of example and not limitation, the user may use the control panel 604 or the mobile device 612 to select the specific warming temperature used in block 1108. The temperature sensors of the device represented by sensors 610 (see FIG. 6), described elsewhere herein, may monitor the temperature inside the containers 200, 800 in the warming mode. By way of example and not limitation, the device may display on the control panel or mobile device recommended warming temperatures depending on the type of food content in the tahdig (e.g., usage of other food such as potatoes or breads). By way of example and not limitation, the warming mode may run continuously until the user terminates it or may terminate automatically after the lapse of a specific time duration. By way of example and not limitation, the control panel 604 or mobile device 612 may also display an indication when the crisping mode is complete for a user to collect the tahdig while also running the warming mode after the generation of the indication. By way of example and not limitation, the control panel 604 and mobile device 612 may generate a separate indication that the device and the food are in warming mode.

As described elsewhere herein, the blocks of method 1100 shown in FIG. 11 may operate consecutively without user intervention, or a pause may occur between some of the blocks for a user to add ingredients to create the desired texture and taste of tahdig. Additionally, pasta may be used instead of rice to make tahdig in method 1100 of FIG. 11. Similar functions and steps, described elsewhere herein, may also apply to making a tahdig from pasta.

As discussed herein, the device and method were described in relation to the production of tahdig or crispy rice. However, the device and method may be utilized in relation to production of pizza and frittata or other dishes.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A multi-level crispy food cooker, comprising:
an outer shell body having an interior with a plurality of cavity levels compartmentalized by one or more horizontal dividers, the outer shell body having an opening for each cavity level that is each covered by an outer casing structure having a gripping handle;
a plurality of slidable containers, each slidable container corresponding to one of the plurality of cavity levels, each slidable container attached to a corresponding outer casing structure covering each cavity level, each slidable container made from a ferrous material and configured to slide inwards and outwards of a corresponding cavity level using the corresponding outer casing structure;
a plurality of heating mechanisms corresponding to the plurality of cavity levels, each heating mechanism on a bottom surface of each cavity level, each heating mechanism having an inductive coil that is covered by a heat-resistive material; and
a control panel on an outside of the outer shell body configured to operate the multi-level crispy food cooker.

2. The multi-level crispy food cooker of claim 1, wherein each slidable container has a container body and a container lid.

3. The multi-level crispy food cooker of claim 2, wherein the container body of each slidable container has an inner segment and an outer segment.

4. The multi-level crispy food cooker of claim 3, wherein the inner segment is made from a food-safe material and the outer segment is made from the ferrous material.

5. The multi-level crispy food cooker of claim 1, further comprising a processor inside the outer shell body and connected to the plurality of heating mechanisms.

6. The multi-level crispy food cooker of claim 5, wherein the processor controls the plurality of heating mechanisms and is configured to determine to turn on for operation which inductive coil of each heating mechanism by detecting the ferrous material of the plurality of slidable containers using the inductive coil of each heating mechanism.

7. The multi-level crispy food cooker of claim 5, wherein the processor is configured to determine to turn on for operation one or more of the inductive coils by partially turning on one or more of the inductive coils of the plurality of heating mechanisms and determining which one or more of the inductive coils is detecting eddy current.

8. The multi-level crispy food cooker of claim 1, wherein a heating temperature of each heating mechanism is adjustable using the control panel.

9. The multi-level crispy food cooker of claim 1, wherein the multi-level crispy food cooker is also configured to be operated by a mobile device.

10. The multi-level crispy food cooker of claim 9, wherein the mobile device is connected to the multi-level crispy food cooker by Bluetooth or Wi-Fi.

11. A multi-level crispy food cooker, comprising:
a body having an outer shell and an inner wall and a gap therebetween, the inner wall defining a stacking cavity in a center of the body;
a plurality of inductive coil rings stacked above each other in the gap between the outer shell and the inner wall of the body, the plurality of inductive coil rings encircling the stacking cavity;
a plurality of stackable containers each made from a ferrous material stacked on top of each other in the stacking cavity;
a processor inside the body and connected to the plurality of inductive coil rings; and
a control panel on an outside of the body, the control panel configured for controlling one or more operations of the multi-level crispy food cooker.

12. The multi-level crispy food cooker of claim 11, wherein the plurality of stackable containers come in different depth heights.

13. The multi-level crispy food cooker of claim 11, wherein each stackable container has a container body and a container lid.

14. The multi-level crispy food cooker of claim 13, wherein the container body of each stackable container has an inner segment and an outer segment.

15. The multi-level crispy food cooker of claim 14, wherein the inner segment is made from a food-safe material and the outer segment is made from the ferrous material.

16. The multi-level crispy food cooker of claim 11, wherein the multi-level crispy food cooker is also configured to be operated by a mobile device.

17. The multi-level crispy food cooker of claim 15, wherein the inner segment of each stackable container has a non-stick coating in an interior surface of the container body.

18. The multi-level crispy food cooker of claim 11, wherein the processor is electrically connected to the plurality of inductive coil rings and configured to determine to turn on for operation one or more of said inductive coil rings by detecting the ferrous material of the plurality of stackable containers using the plurality of inductive coil rings.

19. The multi-level crispy food cooker of claim 11, wherein the processor is configured to determine to turn on for operation one or more of the inductive coil rings by partially turning on each one or more of the inductive coil rings of the plurality of inductive coil rings and determining which one or more of the inductive coil rings is detecting eddy current.

20. The multi-level crispy food cooker of claim 16, wherein the mobile device is connected to the multi-level crispy food cooker by Bluetooth or Wi-Fi.
